(19) United States
(12) Patent Application Publication
(10) Pub. No.: US 2007/0181163 A1
(43) Pub. Date: Aug. 9, 2007

(54) Electronic device cleaning equipment and electronic device cleaning method

(76) Inventors: Yukihisa Wada, Kyoto (JP); Masayuki Watanabe, Toyama (JP); Kazuhide Saito, Toyama (JP)

Correspondence Address: MCDERMOTT WILL & EMERY LLP, 600 13TH STREET, N.W., WASHINGTON, DC, 20005-3096, US

(21) Appl. No.: 11/583,847

(22) Filed: Oct. 20, 2006

(30) Foreign Application Priority Data
Feb. 9, 2006 (JP) 2006-032403

(51) Int. Cl. C23G 1/00; B08B 3/00

(52) U.S. Cl. 134/26; 134/94.1; 134/2; 134/34

(57) ABSTRACT

Electronic device cleaning equipment includes a cleaning stage having a processing face on which a substrate having an obverse face at which an electronic device is formed is to be placed, a vapor supply nozzle for supplying vapor to the obverse face of the substrate, and chemical solution supply means for supplying a chemical solution to the obverse face of the substrate. Accordingly, static electricity present on the obverse face of the substrate is diselectrified.

### CROSS REFERENCE TO RELATED APPLICATIONS

This Non-provisional application claims priority under 35 U.S.C. §119(a) on Patent Application No. 2006-032403 filed in Japan on Feb. 9, 2006, the entire contents of which are hereby incorporated by reference.

### BACKGROUND OF THE INVENTION

The present invention relates to electronic device cleaning equipment and an electronic device cleaning method, and particularly relates to single-wafer electronic device cleaning equipment and a single-wafer electronic device cleaning method which can prevent flaws at the obverse face of an electronic device.

Recently, demands for high speed and highly integrated electronic devices are increasing, and miniaturization and a diameter increase of electronic devices are being promoted for realizing the demand. Under the circumstances, cleaning methods for electronic devices are in transition from batch cleaning to single-wafer cleaning for enhancing controllability in a region subjected to cleaning.

In a conventional single-wafer cleaning method, as shown in FIG. 14A, after a wafer 1 is placed on a processing face of a cleaning stage 114 with a chuck pin 115 interposed, the obverse face of the wafer 1 is etched in such a manner that a chemical solution is discharged onto the obverse face of the wafer 1 from a chemical solution nozzle 111 while the wafer 1 held on the cleaning stage 114 is rotated by a rotary table 116. Subsequently, as shown in FIG. 14B, the obverse face of the wafer 1 is cleaned with water by discharging water onto the obverse face of the wafer 1 from a water cleaning nozzle 112. Then, as shown in FIG. 14C, the obverse face of the wafer 1 is dried in such a manner that the wafer 1 held on the cleaning stage 114 is rotated by the rotary table 116 to shake off water remaining on the obverse face of the wafer 1.

In the above conventional electronic device cleaning method, however, involves the following problems.

Namely, in the conventional electronic device cleaning method, static electricity is charged on the obverse face of the wafer 1 and at the chemical solution nozzle 111.

One of concrete examples where static electricity is charged on the obverse face of the wafer 1 will be described.

In the conventional electronic device cleaning method, rotation of the cleaning stage 114 that holds the wafer 1 by the rotary table 116 causes friction with air, thereby charging static electricity on the obverse face of the cleaning stage 114. Therefore, the static electricity is present on the processing face of the cleaning stage 114. Under this state, when the wafer 1 having an obverse face on which, for example, an insulating film (not shown) is formed is cleaned, the static electricity present on the processing face of the cleaning stage 114 is induced to the obverse face of the wafer 1 placed on the processing face of the cleaning stage 114 to cause charge of the static electricity on the obverse face of the wafer 1.

One of concrete examples where static electricity is charged at the chemical solution nozzle 111 will be described next.

In the conventional electronic device cleaning method, when a chemical solution is discharged onto the obverse face of the wafer 1 from the chemical solution nozzle 111, mutual friction is caused between the chemical solution nozzle 111 (especially, a discharge port thereof) and the chemical solution, resulting in charge of static electricity at the chemical solution nozzle 111.

The charge of static electricity on the obverse face wafer 1 and at the chemical solution nozzle 111 causes potential difference between the obverse face of the wafer 1 and the chemical solution nozzle 111 to cause static electricity discharge in a space between the obverse face of the wafer 1 and the chemical solution nozzle 111 at chemical solution discharge in the cleaning process. As a result, flaws by static electricity are formed at the obverse face of the wafer 1 (especially, a part of the insulating film where the chemical solution is supplied), lowering the yield of the electronic device in the conventional electronic device cleaning methods.

For tackling this problem, a prior art electronic device cleaning method was proposed for preventing flaws from being formed at the obverse face of a wafer (especially, a circuit part thereof). In this method, a chemical solution is discharged first onto a non-circuit part of a wafer and then is discharged onto the circuit part of the wafer by a chemical solution nozzle capable of moving over the wafer (see, for example, Japanese Patent Application Laid Open Publication No. 11-233473A).

According to this method, though flaws by static electricity may be formed by the static electricity discharge in a part of the wafer where the chemical solution is supplied first, that is, the non-circuit part at the edge portion of the wafer, they are not formed in the circuit part of the wafer, attaining electronic device cleaning with no lowering of the yield of the electronic device.

The prior art electronic device cleaning method, however, involves the following problems.

In the prior art electronic device cleaning method, the chemical solution must be discharged onto the non-circuit part at the edge portion of the wafer from the chemical solution nozzle. The selective discharge onto the non-circuit part is difficult, and therefore, the chemical solution may be discharged onto a part other than the non-circuit part at the edge portion of the wafer, that is, the circuit part of the wafer, to form flaws by the static electricity discharge at a part of the circuit part of the wafer where the chemical solution is discharged. Further, particles may adhere to the obverse face of the wafer by the static electricity discharge.

In addition, the chemical solution collides with the edge of the wafer and is scattered in discharging the chemical solution, so that the chemical solution cannot be recovered to the cleaning cup and the scattered chemical solution adheres to the obverse face of the wafer, resulting in contamination of the obverse face of the wafer.

As described above, in the conventional electronic device cleaning methods, due to the potential difference between the obverse face of the wafer and the chemical solution nozzle, static electricity is discharged in the space between the obverse face of the wafer and the chemical solution nozzle at chemical solution discharge, generating defects at the wafer (specifically, flaws by static electricity and particles) to lower the yield of the electronic device.

### SUMMARY OF THE INVENTION

The present embodiment has been made in view of the foregoing and has its object of providing electronic device cleaning equipment and an electronic device cleaning method which can prevent static electricity discharge in a space between the obverse face of a wafer and a chemical solution nozzle at chemical solution discharge in such a manner that at least one of static electricity present on the obverse face of the wafer and static electricity present at the chemical solution nozzle is diselectrified for reducing potential difference between the obverse face of the wafer and the chemical solution nozzle.

To solve the above problems, electronic device cleaning equipment according to a first aspect of the present invention includes: a cleaning stage having a processing face on which a substrate having an obverse face at which an electronic device is formed is to be placed; a vapor supply nozzle for supplying vapor to the obverse face of the substrate; and chemical solution supply means for supplying a chemical solution to the obverse face of the substrate.

In the electronic device cleaning equipment according to the first aspect of the present invention, the vapor is supplied to the obverse face of the substrate by the vapor supply nozzle to cause neutralization of static electricity present on the obverse face of the substrate by ionized vapor, diselectrifying the static electricity present on the obverse face of the substrate.

Accordingly, static electricity is prevented from being discharged in the space between the obverse face of the substrate and the supplied chemical solution, preventing formation of flaws by static electricity at the obverse face of the substrate (especially, a part of the obverse face of the substrate where the chemical solution is supplied) and adhesion of particles thereto, which are caused by static electricity discharge.

Hence, in the electronic device cleaning equipment according to the first aspect of the present invention, an electronic device can be cleaned favorably with no defects (especially, flaws by static electricity and particles) generated at the obverse face of the substrate, increasing the yield of the electronic device.

In the electronic device cleaning equipment according to the first aspect of the present invention, the chemical solution supply means is preferably a chemical solution nozzle for discharging the chemical solution to the obverse face of the substrate.

With the above arrangement, as described above, the vapor supplied to the obverse face of the substrate diselectrifies static electricity present on the obverse face of the substrate, reducing the potential difference between the obverse face of the substrate and the chemical solution nozzle. As a result, static electricity is prevented from being discharged in the space between the obverse face of the substrate and the chemical solution nozzle.

In the electronic device cleaning equipment according to the first aspect of the present invention, the vapor supply nozzle is preferably in the form capable of being arranged along the periphery of the cleaning stage above the cleaning stage.

With the above arrangement, the vapor can be sprayed to the obverse face of the substrate placed on the processing face by the vapor supply nozzle arranged along the periphery of the cleaning stage above the cleaning stage, attaining efficient supply of the vapor to the obverse face of the substrate to cause diselectrification of static electricity present on the obverse face of the substrate effectively.

To solve the above mentioned problems, electronic device cleaning equipment according to a second aspect of the present invention includes: a cleaning stage having a processing face on which a substrate having an obverse face at which an electronic device is formed is to be placed; a chemical solution nozzle for supplying a chemical solution to the obverse face of the substrate; and a vapor supply nozzle for supplying vapor to the chemical solution nozzle.

In the electronic device cleaning equipment according to the second aspect of the present invention, the vapor is supplied to the chemical solution nozzle by the vapor supply nozzle to cause neutralization of static electricity present at the chemical solution nozzle by ionized vapor, diselectrifying the static electricity present at the chemical solution nozzle. Thus, the potential of the chemical solution nozzle can be lowered.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Hence, the electronic device cleaning equipment according to the second aspect of the present invention attains favorable cleaning of an electronic device with no defects (specifically, flaws by static electricity and particles) generated at the obverse face of the substrate, increasing the yield of the electronic device.

In the electronic device cleaning equipment according to the second aspect of the present invention, the vapor supply nozzle is preferably in the form capable of surrounding a discharge port of the chemical solution nozzle.

With the above arrangement, the vapor is sprayed to the chemical solution nozzle by the vapor supply nozzle arranged so as to surround the discharge port of the chemical solution nozzle, resulting in efficient supply of the vapor to the discharge port of the chemical solution nozzle. This leads to effective diselectrification of static electricity present at the discharge port of the chemical solution nozzle, effectively reducing the potential difference between the chemical solution nozzle and the obverse face of the substrate.

Further, when the vapor is supplied to the discharge port of the chemical solution nozzle, the discharge port of the chemical solution nozzle is cleaned, so that the chemical solution nozzle is kept clean, attaining further favorable cleaning of the electronic device.

In the electronic device cleaning equipment according to the first or second aspect of the present invention, the vapor preferably includes at least one of water, soda water, and alcohol.

In this case, the vapor including water, soda water, or alcohol and supplied to the obverse face of the substrate (or the chemical solution nozzle) diselectrifies static electricity present on the obverse face of the substrate (or at the chemical solution nozzle).

To solve the above mentioned problems, electronic device cleaning equipment according to a third aspect of the present invention includes: a cleaning stage having a processing face on which a substrate having an obverse face at which an electronic device is formed is to be placed; a chemical solution nozzle for supplying a chemical solution to the obverse face of the substrate; and a conductive cup which retains a solution and is electrically grounded, a discharge port of the chemical solution nozzle being to be dipped into the solution.

In the electronic device cleaning equipment according to the third aspect of the present invention, the discharge port of the chemical solution nozzle is dipped into the solution retained in the electrically grounded conductive cup to cause neutralization of static electricity present at the chemical solution nozzle, diselectrifying the static electricity present at the chemical solution nozzle. Thus, the potential of the chemical solution nozzle (especially, the discharge port thereof) can be lowered.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Hence, the electronic device cleaning equipment according to the third aspect of the present invention attains favorable cleaning of an electronic device with no defects (specifically, flaws by static electricity and particles) generated on the obverse face of the substrate, increasing the yield of the electronic device.

Further, in the electronic device cleaning equipment according to the third aspect of the present invention, when the discharge port of the chemical solution nozzle is dipped into the solution retained in the electrically grounded conductive cup, crystals as a precipitate of the chemical solution adhering to the discharge port of the chemical solution nozzle can be dissolved and removed in the solution surely. Particles are generated in such a way that such crystals fall on and adhere to the obverse face of a wafer. However, no crystals adhere to the discharge port of the chemical solution nozzle and fall on the obverse face of the wafer in this aspect. As a result, particles are prevented from being generated on the obverse face of the wafer, attaining further favorable cleaning of the electronic device.

In the electronic device cleaning equipment according to the third aspect of the present invention, the solution preferably includes at least one of a chemical solution, soda water, and water.

In this case, the chemical solution, the soda water, or the water, which is grounded electrically, diselectrifies static electricity present at the chemical solution nozzle.

To solve the above mentioned problems, electronic device cleaning equipment according to a fourth aspect of the present invention includes: a cleaning stage having a processing face on which a substrate having an obverse face at which an electronic device is formed is to be placed; a chemical solution nozzle for supplying a chemical solution to the obverse face of the substrate; and a conductive member for diselectrifying static electricity present at the chemical solution nozzle, the conductive member being grounded electrically.

In the electronic device cleaning equipment according to the fourth aspect of the present invention, the chemical solution nozzle is allowed to be in contact with or approach the electrically grounded conductive member, so that static electricity present at the chemical solution nozzle is neutralized. As a result, the static electricity present at the chemical solution nozzle is diselectrified, lowering the potential of the chemical solution nozzle.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Thus, the electronic device cleaning equipment according to the fourth aspect of the present invention attains favorable cleaning of an electronic device with no defects (specifically, flaws by static electricity and particles) generated at the obverse face of the substrate, increasing the yield of the electronic device.

Further, in the electronic device cleaning equipment according to the fourth aspect of the present invention, when the chemical solution nozzle is in contact with or approaches the electrically grounded conductive member, static electricity present at the chemical solution nozzle is diselectrified with no chemical solution nozzle wetted. Hence, in contrast to the electronic device cleaning equipment according to the second and third aspects of the present invention, the chemical solution nozzle does not get wet by the vapor supplied to the chemical solution nozzle and the solution. Accordingly, a phenomenon is prevented in which a component of the vapor or the solution other than the chemical solution is mixed with the chemical solution discharged onto the obverse face of the substrate from the chemical solution nozzle, so that change in composition of the chemical solution is not caused. Hence, the cleaning ability for an electronic device is prevented from varying, attaining further favorable cleaning of the electronic device.

In the electronic device cleaning equipment according to the fourth aspect of the present invention, the conductive member is preferably in the form capable of surrounding a discharge port of the chemical solution nozzle.

In this case, the conductive member is arranged so as to surround the discharge port of the chemical solution nozzle and is electrically grounded so that the discharge port of the chemical solution nozzle can be inserted therein for being in contact with the conductive member. As a result, static electricity present at the discharge port of the chemical solution nozzle can be diselectrified effectively, reducing the potential difference between the chemical solution nozzle and the obverse face of the substrate effectively.

Further, when the conductive member is arranged so as to surround the side face of the chemical solution nozzle, every part of the side face of the chemical solution nozzle can be allowed to approach the conductive member, attaining effective diselectrification of static electricity present at the chemical solution nozzle. Particularly, in a case with considerable amount of charges at the chemical solution nozzle, the static electricity present at the chemical solution nozzle can be diselectrified surely only by allowing the chemical solution nozzle to approach the conductive member. The chemical solution nozzle needs not be surely in contact with the conductive member.

To solve the above mentioned problems, an electronic device cleaning method according to a first aspect of the present invention includes the steps of: (a) placing, on a processing face of a cleaning stage, a substrate having an obverse face at which an electronic device is formed; (b) supplying vapor to the obverse face of the substrate; and (c) supplying a chemical solution to the obverse face of the substrate after the step (b).

In the electronic device cleaning method according to the first aspect of the present invention, supplying the vapor to the obverse face of the substrate leads to neutralization of static electricity present on the obverse face of the substrate by ionized vapor, thereby diselectrifying the static electricity present at the obverse face of the substrate.

Accordingly, static electricity is prevented from being discharged in the space between the obverse face of the substrate and the supplied chemical solution, preventing formation of flaws by static electricity at the obverse face of the substrate (especially, a part of the obverse face of the substrate where the chemical solution is supplied) and adhesion of particles thereto, which are caused by static electricity discharge.

Hence, in the electronic device cleaning method according to the first aspect of the present invention, an electronic device can be cleaned favorably with no defects (especially, flaws by static electricity and particles) generated at the obverse face of the substrate, increasing the yield of the electronic device.

In the electronic device cleaning method according to the first aspect of the present invention, it is preferable that in the step (c), the chemical solution is discharged to the obverse face of substrate from a chemical solution nozzle.

With the above arrangement, as described above, the vapor supplied to the obverse face of the substrate diselectrifies static electricity present on the obverse face of the substrate, reducing the potential difference between the obverse face of the substrate and the chemical solution nozzle. As a result, static electricity is prevented from being discharged in the space between the obverse face of the substrate and the chemical solution nozzle.

In the electronic device cleaning method according to the first aspect of the present invention, it is preferable that in the step (b), the vapor is sprayed to the obverse face of the substrate by a vapor supply nozzle arranged along the periphery of the cleaning stage above the cleaning stage.

With the above arrangement, the vapor can be sprayed to the substrate placed on the processing face by the vapor supply nozzle arranged along the periphery of the cleaning stage above the cleaning stage, attaining efficient supply of the vapor to the obverse face of the substrate to lead to effective diselectrification of static electricity present on the obverse face of the substrate.

To solve the above mentioned problems, an electronic device cleaning method according to a second aspect of the present invention includes the steps of: (a) placing, on a processing face of a cleaning stage, a substrate having an obverse face at which an electronic device is formed; (b) supplying vapor to a chemical solution nozzle; and (c) supplying a chemical solution to the obverse face of the substrate from the chemical solution nozzle after the step (b).

In the electronic device cleaning method according to the second aspect of the present invention, the vapor is supplied to the chemical solution nozzle to cause neutralization of static electricity present at the chemical solution nozzle by ionized vapor, thereby diselectrifying the static electricity present at the chemical solution nozzle. Thus, the potential at the chemical solution nozzle can be lowered.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Hence, the electronic device cleaning method according to the second aspect of the present invention attains favorable cleaning of an electronic device with no defects (specifically, flaws by static electricity and particles) generated at the obverse face of the substrate, increasing the yield of the electronic device.

In the electronic device cleaning method according to the second aspect of the present invention, it is preferable that in the step (b), the vapor is sprayed to the chemical solution nozzle by a vapor supply nozzle arranged so as to surround a discharge port of the chemical solution nozzle.

With the above arrangement, the vapor is sprayed to the chemical solution nozzle by the vapor supply nozzle arranged so as to surround the discharge port of the chemical solution nozzle, resulting in efficient supply of the vapor to the discharge port of the chemical solution nozzle. This leads to effective diselectrification of static electricity present at the discharge port of the chemical solution nozzle, effectively reducing the potential difference between the chemical solution nozzle and the obverse face of the substrate.

Further, when the vapor is supplied to the discharge port of the chemical nozzle, the discharge port of the chemical solution nozzle is cleaned, so that the chemical solution nozzle is kept clean, attaining further favorable cleaning of the electronic device.

In the electronic device cleaning method according to the first or second aspect of the present invention, it is preferable that the vapor includes at least one of water, soda water, and alcohol.

In this case, the vapor including the water, the soda water, or the alcohol and supplied to the obverse face of the substrate (or the chemical solution nozzle) diselectrifies static electricity present on the obverse face of the substrate (or at the chemical solution nozzle).

To solve the above mentioned problems, an electronic device cleaning method according to a third aspect of the present invention include the steps of: (a) placing, on a processing face of a cleaning stage, a substrate having an obverse face at which an electronic device is formed; (b) dipping a discharge port of a chemical solution nozzle into an electrically grounded solution; and (c) supplying a chemical solution to the obverse face of the substrate from the chemical solution nozzle after the step (b).

In the electronic device cleaning method according to the third aspect of the present invention, the discharge port of the chemical solution nozzle is dipped into the electrically grounded solution to cause neutralization of static electricity present at the chemical solution nozzle, diselectrifying the static electricity present at the chemical solution nozzle. Thus, the potential of the chemical solution nozzle (especially, the discharge port thereof) can be lowered.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Hence, the electronic device cleaning method according to the third aspect of the present invention attains favorable cleaning of an electronic device with no defects (specifically, flaws by static electricity and particles) generated at the obverse face of the substrate, increasing the yield of the electronic device.

Further, in the electronic device cleaning method according to the third aspect of the present invention, when the discharge port of the chemical solution nozzle is dipped into the solution, crystals as a precipitate of the chemical solution adhering to the discharge port of the chemical solution nozzle are dissolved and removed surely in the solution. Particles are generated in such a way that such crystals fall on and adhere to the obverse face of a wafer. However, no crystals adhere to the discharge port of the chemical solution nozzle and fall on the obverse face of the wafer in this aspect. As a result, particles are prevented from being generated on the obverse face of the wafer, attaining further favorable cleaning of the electronic device.

In the electronic device cleaning method according to the third aspect of the present invention, it is preferable that the solution includes at least one of a chemical solution, soda water, and water.

In this case, the chemical solution, the soda water, or the water, which is grounded electrically, diselectrifies static electricity present at the chemical solution nozzle.

To solve the above descried problems, an electronic device cleaning method according to a fourth aspect of the present invention includes the steps of: (a) placing, on a processing face of a cleaning stage, a substrate having an obverse face at which an electronic device is formed; (b) diselectrifying static electricity present at a chemical solution nozzle with the use of an electrically grounded conductive member; and (c) supplying a chemical solution to the obverse face of the substrate from the chemical solution nozzle after the step (b).

In the electronic device cleaning method according to the fourth aspect of the present invention, the chemical solution nozzle is allowed to be in contact with or approach the electrically grounded conductive member, so that static electricity present at the chemical solution nozzle is neutralized. As a result, the static electricity present at the chemical solution nozzle can be diselectrified, lowering the potential of the chemical solution nozzle.

Accordingly, the potential difference between the chemical solution nozzle and the obverse face of the substrate can be reduced, so that static electricity is prevented from being discharged in the space between the obverse face of the substrate and the chemical solution nozzle. This prevents formation of flaws by static electricity at the obverse face of the substrate and adhesion of particles thereto, which are caused by static electricity discharge.

Hence, the electronic device cleaning method according to the fourth aspect of the present invention attains favorable cleaning of an electronic device with no defects (specifically, flaws by static electricity and particles) generated at the obverse face of the substrate, increasing the yield of the electronic device.

Further, in the electronic device cleaning method according to the fourth aspect of the present invention, when the chemical solution nozzle is in contact with or approaches the electrically grounded conductive member, static electricity present at the chemical solution nozzle is diselectrified with no chemical solution nozzle wetted. Hence, in contrast to the electronic device cleaning methods according to the second and third aspects of the present invention, the chemical solution nozzle does not get wet by the vapor supplied to the chemical solution nozzle and the solution in the diselectrification step. Accordingly, a phenomenon is prevented in which a component of the vapor or the solution other than the chemical solution is mixed with the chemical solution discharged onto the obverse face of the substrate from the chemical solution nozzle, so that change in composition of the chemical solution is not caused. Hence, the cleaning ability for an electronic device is prevented from varying, attaining further favorable cleaning of the electronic device.

In the electronic device cleaning method according to the fourth aspect of the present invention, it is preferable that in the step (b), the static electricity present at the chemical solution nozzle is diselectrified with the use of the conductive member arranged so as to surround a discharge port of the chemical solution nozzle.

In this case, the conductive member is arranged so as to surround the discharge port of the chemical solution nozzle and is electrically grounded so that the discharge port of the chemical solution nozzle can be inserted therein for being in contact with the conductive member. As a result, static electricity present at the discharge port of the chemical solution nozzle can be diselectrified effectively, reducing the potential difference between the chemical solution nozzle and the obverse face of the substrate effectively.

Further, when the conductive member is arranged so as to surround the side face of the chemical solution nozzle, every part of the side face of the chemical solution nozzle can be allowed to approach the conductive member, attaining effective diselectrification of static electricity present at the chemical solution nozzle. Particularly, in a case with considerable amount of charges at the chemical solution nozzle, the static electricity present at the chemical solution nozzle can be diselectrified surely only by allowing the chemical solution nozzle to approach the conductive member. The chemical solution nozzle needs not be surely in contact with the conductive member.

As described above, in the electronic device cleaning equipment and the electronic device cleaning method according to the present invention, the potential difference between the obverse face of the substrate and the chemical solution nozzle is reduced, preventing static electricity from being discharged in the space between the obverse face of the substrate and the chemical solution nozzle with the yields of the electronic device increased.

### BRIEF DESCRIPTION OF THE DRAWINGS

FIG. 1 is a sectional view showing a construction of electronic device cleaning equipment according to Embodiment 1 of the present invention.

FIG. 2 is a plan view showing the construction of the electronic device cleaning equipment according to Embodiment 1 of the present invention.

FIG. 3A to FIG. 3D are sectional views showing main steps of an electronic device cleaning method according to Embodiment 1 of the present invention.

FIG. 4A is a sectional view showing a structure of a wafer subjected to a conventional electronic device cleaning method, and FIG. 4B is a sectional view showing a structure of a wafer subjected to the electronic device cleaning method according to Embodiment 1 of the present invention.

FIG. 5A is a plan view showing a construction of electronic device cleaning equipment according to Embodiment 2 of the present invention, and FIG. 5B is an enlarged view of a characteristic part thereof.

FIG. 6A to FIG. 6D are sectional views showing main steps of an electronic device cleaning method according to Embodiment 2 of the present invention.

FIG. 7A to FIG. 7D are sectional views showing main steps of an electronic device cleaning method according to Modified Example 1.

FIG. 8A is a plan view showing a construction of electronic device cleaning equipment according to Embodiment 3 of the present invention, and FIG. 8B is an enlarged view of a characteristic part thereof.

FIG. 9A to FIG. 9D are sectional views showing main steps of an electronic device cleaning method according to Embodiment 3 of the present invention.

FIG. 10A to FIG. 10D are sectional views showing main steps of an electronic device cleaning method according to Modified Example 2.

FIG. 11A is a plan view showing a construction of electronic device cleaning equipment according to Embodiment 4 of the present invention, and FIG. 11B is an enlarged view of a characteristic part thereof.

FIG. 12A to FIG. 12D are sectional views showing main steps of an electronic device cleaning method according to Embodiment 4 of the present invention.

FIG. 13A to FIG. 13D are sectional views showing main steps of an electronic device cleaning method according to Modified Example 3.

FIG. 14A to FIG. 14C are sectional views showing main steps of the conventional electronic device cleaning method.

### DESCRIPTION OF THE PREFERRED EMBODIMENTS

Embodiments of the present invention will be described below with reference to the accompanying drawings.

### Embodiment 1

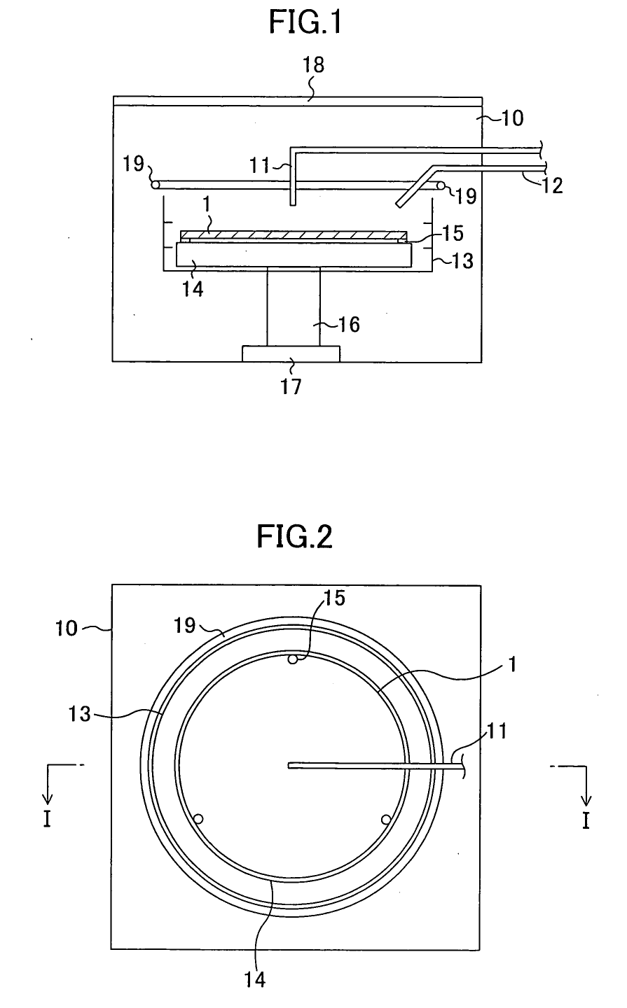

Electronic device cleaning equipment according to Embodiment 1 of the present invention will be described below with reference to FIG. 1 and FIG. 2. FIG. 1 is a sectional view showing a construction of the electronic device cleaning equipment according to Embodiment 1 of the present invention, specifically, a sectional view taken along the line I-I in FIG. 2. FIG. 2 is a plan view showing the construction of the electronic device cleaning equipment according to Embodiment 1 of the present invention, specifically a plan view showing a cleaning chamber as viewed from above.

One of the significant features of the present embodiment lies in that before a chemical solution is discharged onto the obverse face of a wafer from a chemical solution nozzle, water vapor is sprayed to the obverse face of the wafer from a vapor supply nozzle arranged along the periphery of a cleaning stage above the cleaning stage, thereby diselectrifying static electricity present on the obverse face of the wafer.

As shown in FIG. 1, the electronic device cleaning equipment according to the present embodiment includes as main constitutional elements: a cleaning chamber 10; a chemical solution nozzle 11 for discharging a chemical solution onto the obverse face of a wafer 1; a water cleaning nozzle 12 for discharging water onto the obverse face of the wafer 1; a cleaning cup 13 for recovering the chemical solution and the water; a cleaning stage 14 having a processing face on which the wafer 1 is to be placed; a chuck pin 5 for holding the wafer 1; a rotary table 16 for rotating the wafer 1; holding means 7 for holding the cleaning cup 13, the cleaning stage 14, and the rotary table 16; a FFU (fan filter unit) 18 arranged on the cleaning chamber 10; and a vapor supply nozzle 19 for spraying water vapor to the obverse face of the wafer 1. Herein, as shown in FIG. 1 and FIG. 2, the vapor supply nozzle 19 is arranged along the periphery of the cleaning stage 14 above the cleaning stage 14.

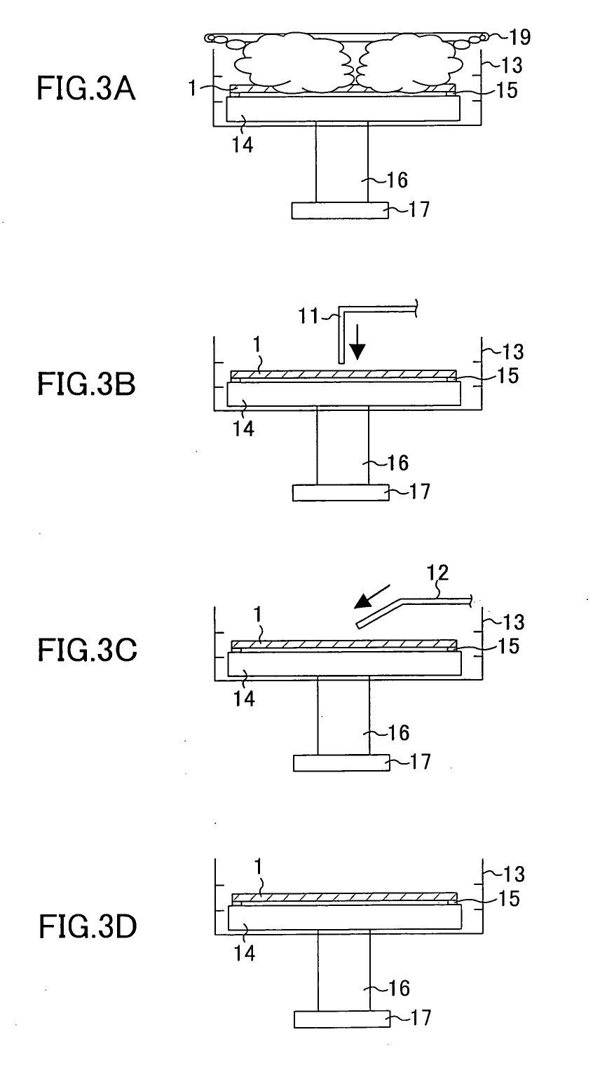

Next, an electronic device cleaning method using the electronic device cleaning equipment according to Embodiment 1 of the present invention will be described with reference to FIG. 3A to FIG. 3D. FIG. 3A to FIG. 3D are sectional views showing main steps of the electronic device cleaning method according to Embodiment 1 of the present invention.

First, as shown in FIG. 3A, the wafer having an obverse face at which an electronic device (not shown) is formed is placed on the processing face of the cleaning stage 14 with the chuck pin 5 interposed. Then, the obverse face of the wafer 1 is subjected to diselectrification for a predetermined diselectrification time period by spraying water vapor to the obverse face of the wafer 1 by the vapor supply nozzle 19 arranged along the periphery of the cleaning stage 14 above the cleaning stage 14.

Next, a shown in FIG. 3B, the obverse face of the wafer 1 is subjected to etching for a predetermined etching time period by discharging a chemical solution onto the obverse face of the wafer 1 from the chemical solution nozzle 11 while rotating the wafer 1 held on the cleaning stage 14 by the rotary table 16.

Subsequently, as shown in FIG. 3C, the obverse face of the wafer 1 is subjected to water cleaning by discharging water onto the obverse face of the wafer 1 from the water cleaning nozzle 12 while rotating the wafer 1 held on the cleaning stage 14 by the rotary table 16. Then, as shown in FIG. 3D, the obverse face of the wafer 1 is subjected to a drying process in such a manner that the wafer 1 held on the cleaning stage 14 is rotated by the rotary table 16 to shake off water remaining on the obverse face of the wafer 1.

In order to prove effectiveness of the present embodiment, the following evaluation was performed on a wafer subjected to a conventional electronic device cleaning method and a wafer subjected to the electronic device cleaning method according to the present embodiment.

### Evaluation Method 1

The wafer was cleaned by the conventional electronic device cleaning method under the following cleaning conditions.

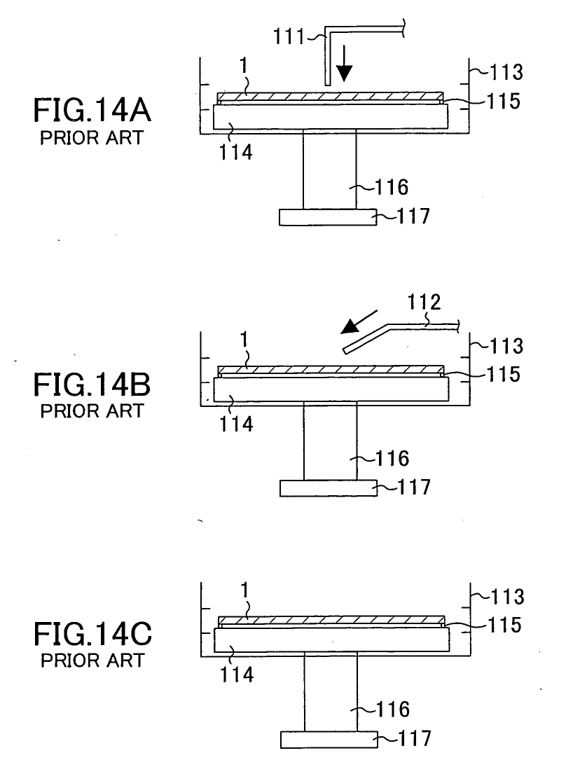

Specifically, with the use of conventional electronic device cleaning equipment, etching was performed on a thermal oxide film (not shown) formed on the wafer 1 and having a thickness of 300 nm, as shown in FIG. 14A, in such a manner that a DHF solution (Diluted Hydrofluoric acid, a mixed solution of which volume ratio of HF:H₂O is 1:10) was discharged onto the thermal oxide film from the chemical solution nozzle 111 for ten seconds at room temperature (23° C.) by a wafer center discharge method while the wafer 1 held on the cleaning stage 114 was rotated by the rotary table 16. The potential measured at the central part of the obverse face of the wafer 1 was −5 kV before the DHF solution was supplied onto the obverse face of the wafer 1. Then, the obverse face of the wafer 1 was water cleaned as shown in FIG. 14B and then was subjected to the drying process as shown in FIG. 14C.

### Evaluation Method 2

The wafer was cleaned by the electronic device cleaning method according to the present embodiment under the following cleaning conditions.

Specifically, the obverse face of the wafer 1 was diselectrified in the electronic device cleaning equipment according to the present embodiment for a predetermined diselectrification time period (30 seconds), as shown in FIG. 3A, in such a manner that water vapor was sprayed to a thermal oxide film (not shown) formed on the wafer 1 and having a thickness of 300 nm by the vapor supply nozzle 19 arranged along the periphery of the cleaning stage 14 above the cleaning stage 14. The potential measured at the central part of the obverse face of the wafer 1 was −0.5 kV after the diselectrification of the wafer 1, namely, before the DHF solution was supplied onto the obverse face of the wafer 1.

Next, as shown in FIG. 3B, etching was performed on the thermal oxide film in such a manner that the DHF solution (Diluted Hydrofluoric acid, a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 3C and then was subjected to the drying process as shown in FIG. 3D.

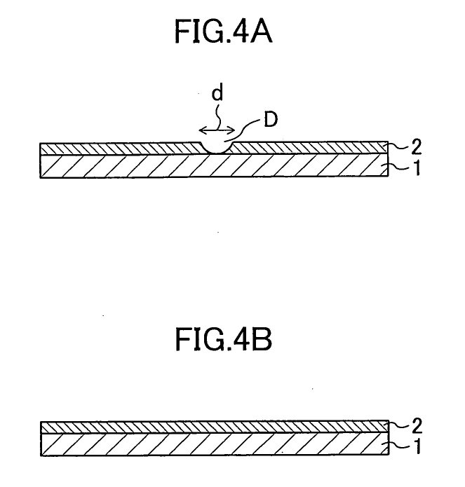

Evaluation of defects was performed on the wafers subjected to the conventional electronic device cleaning method (Evaluation Method 1) or the electronic device cleaning method according to the present embodiment (Evaluation Method 2) under the above cleaning conditions (etching conditions: 23° C., ten seconds, and HF:H₂O=1:10) by counting particles equal to or larger than 0.16 μm as defects by a particle counter. The defects generated at the respective wafers will be described with reference to Table 1, FIG. 4A, and FIG. 4B. Table 1 indicates the numbers and kinds of defects generated at the respective wafers.

TABLE 1

| | | | | Kinds of defects | |
|---|---|---|---|---|---|
| | Number of defects | | | Flaw | |
| | Before | After | Increased | by static | |
| | processing | processing | number | electricity | Particle |
| Conventional | 1 | 8 | 7 | 6 | 1 |
| method | | | | | |
| Embodiment 1 | 2 | 2 | 0 | 0 | 0 |

### Evaluation Result 1

As indicated in Table 1, in the wafer subjected to the conventional electronic device cleaning method, the number of defects before the processing was one while that after the processing was eight, which means an increase in the number of defects after the processing when compared with that before the processing (specifically, seven particles increased). Further, a detailed examination was performed on the seven defects in the wafer observed after the processing with the use of a SEM defect inspection equipment. The defects in the wafer observed after the processing will be described below with reference to FIG. 4A. FIG. 4A is a sectional view showing the structure of the wafer subjected to the conventional electronic device cleaning method.

FIG. 4A shows a hole D having a diameter d of approximately 2 μm formed at the central part of the thermal oxide film formed on the wafer 1. The hole D is a defect generated in such a way that static electricity discharge occurring in the space between the obverse face of the wafer 1 and the chemical solution nozzle 111 damages the thermal oxide film 2. It was confirmed that six defects out of the seven defects observed after the processing were holes D and that a defect other than the holes D, that is, the other defect was a particle (not shown).

### Evaluation Result 2

On the other hand, as indicated in Table 1, in the wafer subjected to the electronic device cleaning method according to the present embodiment, it was conformed that the numbers of defects before and after the processing were both two, which means no increase in the number of defects after the processing when compared with that before the processing. FIG. 4B is a sectional view showing the structure of the wafer subjected to the electronic device cleaning method according to the present embodiment. As shown in FIG. 4B, no flaws by static electricity were observed at the obverse face of the wafer 1 after the processing.

As described above, the number of defects after the cleaning step increased in the wafer subjected to the conventional electronic device cleaning method. In contrast, no increase was observed after the cleaning step in the wafer subjected to the electronic device cleaning method according to the present embodiment. Accordingly, it was found that spraying water vapor to the obverse face of the wafer 1 diselectrifies static electricity present on the obverse face of the wafer 1, thereby reducing the potential difference between the chemical solution nozzle 11 and the obverse face of the wafer 1.

In the electronic device cleaning method according to the present embodiment, as described above, water vapor is sprayed to the obverse face of the wafer 1 by the vapor supply nozzle 19 arranged along the periphery of the cleaning state 14 above the cleaning stage 14, as shown in FIG. 3A, before the cleaning step (see FIG. 3B to FIG. 3D).

Whereby, ionized water vapor neutralizes static electricity present on the obverse face of the wafer 1 to lead to diselectrification of the static electricity present on the obverse face of the wafer 1, thereby lowering the potential of the obverse face of the wafer 1.

Specifically, the potential measured at the central part of the obverse face of the wafer 1 was −5 kV before the DHF solution was supplied onto the obverse face of the wafer 1 in the conventional electronic device cleaning method while the potential measured at the central part of the obverse face of the wafer 1 was −0.5 kV before the DHF solution was supplied onto the obverse face of the wafer 1, namely, after the water vapor was supplied to the obverse face of the wafer 1 in the electronic device cleaning method according to the present embodiment. This means that supplying water vapor to the obverse face of the wafer 1 leads to lowering of the potential at the central part of the obverse face of the wafer 1, namely a part of the obverse face of the wafer 1 where the chemical solution is supplied first.

Accordingly, the potential difference between the obverse face of the wafer 1 and the chemical solution nozzle 11 can be reduced, preventing static electricity from being discharged in the space between the obverse face of the wafer 1 and the chemical solution nozzle 11 at chemical solution supply in the cleaning step (see FIG. 3B). This prevents formation of hole-like flaws D by static electricity at the obverse face of the wafer 1 and adhesion of particles thereto, which are caused by static electricity discharge.

Hence, in the electronic device cleaning method according to the present embodiment, the electronic device can be cleaned favorably with no defects (specifically, flaws by static electricity and particles) generated at the obverse face of the wafer 1, increasing the yield of the electronic device.

### Embodiment 2

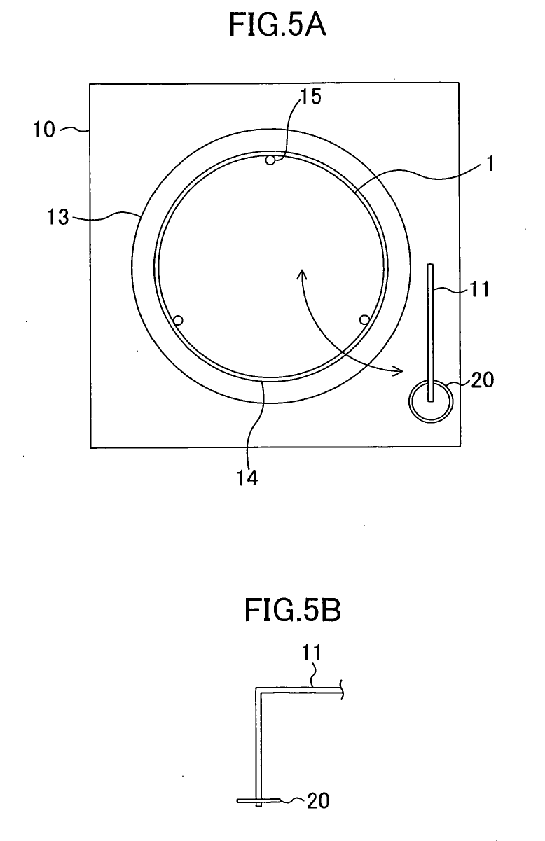

Electronic device cleaning equipment according to Embodiment 2 of the present invention will be described below with reference to FIG. 5A and FIG. 5B. FIG. 5A is a plan view showing a construction of the electronic device cleaning equipment according to Embodiment 2 of the present invention, specifically, a plan view of a cleaning chamber as viewed from above. FIG. 5B is an enlarged view of a characteristic part, namely, a vapor supply nozzle arranged for the chemical solution nozzle and, specifically, an enlarged view thereof as viewed from a side of the chemical solution nozzle. In FIG. 5A and FIG. 5B, the same reference numerals are assigned to the same constitutional elements as those in the electronic device cleaning equipment according to Embodiment 1 of the present invention, and the description of the same constitutional elements is omitted in the present embodiment.

Difference in the present embodiment from Embodiment 1 lies in that before the chemical solution is discharged onto the obverse face of the wafer 1 from the chemical solution nozzle 11, water vapor is sprayed to the obverse face of the wafer 1 in Embodiment 1 while it is sprayed to the chemical solution nozzle 11 in the present embodiment. One of the significant features of the present embodiment is that water vapor is sprayed to the chemical solution nozzle 11 by a vapor supply nozzle 20 arranged so as to surround the discharge port of the chemical solution nozzle 11 for diselectrifying static electricity present at the chemical solution nozzle 11.

As shown in FIG. 5A, the electronic device cleaning equipment according to the present embodiment includes, similarly to that in Embodiment 1 (see FIG. 1): a cleaning chamber 10; a chemical solution nozzle 11; a cleaning nozzle (not shown); a cleaning cup 13; a cleaning stage 14; a chuck pin 15; a rotary table (not shown); holding means (not shown); and a FFU (not shown). Further, it includes, as the most significant feature of the present embodiment, the vapor supply nozzle 20 for spraying water vapor to the chemical solution nozzle 11. As shown in FIG. 5B, the vapor supply nozzle 20 is arranged so as to surround the discharge port of the chemical solution nozzle 11, wherein it is arranged in a perpendicular direction relative to the chemical solution nozzle 11 as viewed from a side of the chemical solution nozzle 11.

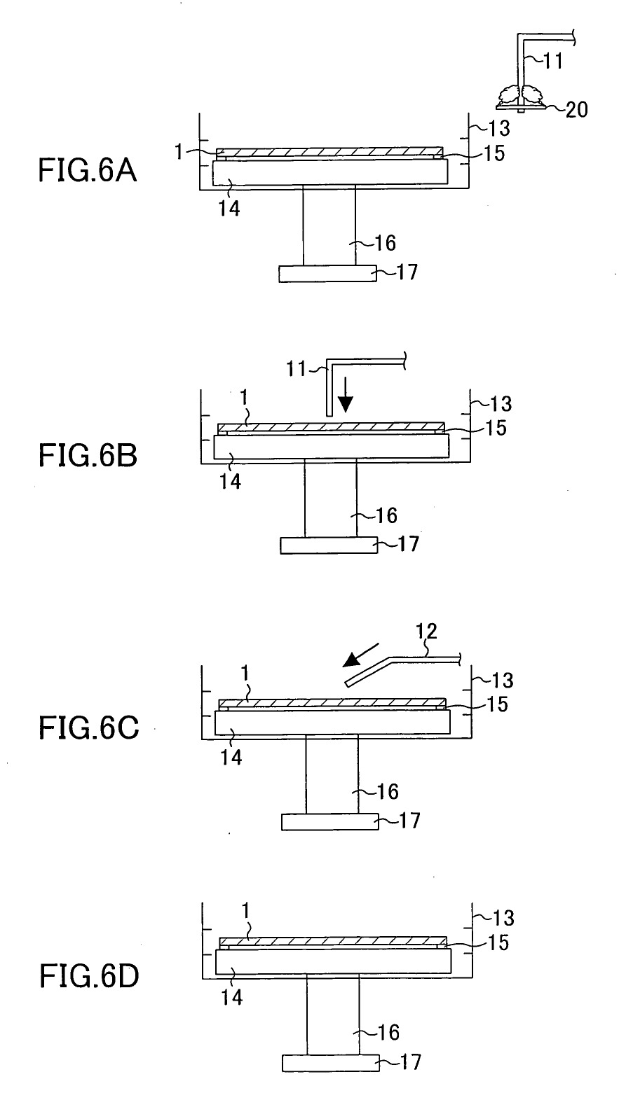

An electronic device cleaning method using the electronic device cleaning equipment according to Embodiment 2 of the present invention will be described with reference to FIG. 6A to FIG. 6D. FIG. 6A to FIG. 6D are sectional views showing main steps of the electronic device cleaning method according to Embodiment 2 of the present invention.

First, as shown in FIG. 6A, a wafer 1 having an obverse face at which an electronic device (not shown) is formed is placed on the processing face of the cleaning stage 14 with the chuck pin 5 interposed. Then, the chemical solution nozzle 11 is subjected to diselectrification for a predetermined diselectrification time period in such a manner that water vapor is sprayed to the chemical solution nozzle 11 by the vapor supply nozzle 20 arranged so as to surround the discharge port of the chemical solution nozzle 11.

Next, as shown in FIG. 6B, similarly to Embodiment 1, etching is performed on the obverse face of the wafer 1 for a predetermined etching time period in such a manner that a chemical solution is discharged onto the obverse face of the wafer 1 from the chemical solution nozzle 11 while the wafer 1 held on the cleaning stage 14 is rotated by the rotary table 16. Then, the obverse face of the wafer 1 is water cleaned as shown in FIG. 6C and then is subjected to the drying process as shown in FIG. 6D.

In order to prove effectiveness of the present embodiment, the following evaluation was performed on a wafer subjected to the conventional electronic device cleaning method, a wafer subjected to the electronic device cleaning method according to the present embodiment, and a wafer subjected to an electronic device cleaning method according to Modified Example 1.

### Evaluation Method 3

A wafer was cleaned by the conventional electronic device cleaning method. Evaluation Method 3 in the present embodiment is the same as Evaluation Method 1 in Embodiment 1 (see Evaluation Method 1), and therefore, the description of Evaluation Method 3 is omitted in the present embodiment. The potential measured at the discharge port of the chemical solution nozzle 111 was −5 kV before the DHF solution was supplied onto the obverse face of the wafer 1.

### Evaluation Method 4

A wafer was cleaned by the electronic device cleaning method according to the present embodiment under the following conditions.

Specifically, the chemical solution nozzle 11 was diselectrified for a predetermined diselectrification time period (30 seconds), a shown in FIG. 6A, in such a manner that water vapor was sprayed to the chemical solution nozzle 11 by the vapor supply nozzle 20 arranged so as to surround the discharge port of the chemical solution nozzle 11. The potential measured at the discharge port of the chemical solution nozzle 1 was −1 kV after the diselectrification of the chemical solution nozzle 11, namely, before the DHF solution was supplied onto the obverse face of the wafer 1.

Subsequently, as shown in FIG. 6B, etching was performed on a thermal oxide film (not shown) formed on the wafer 1 and having a thickness of 300 nm in such a manner that the DHF solution (Diluted Hydrofluoric acid, a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 6C and then was subjected to the drying process as shown in FIG. 6D.

### Evaluation Method 5

A wafer was cleaned by the electronic device cleaning method according to Modified Example 1 under the following conditions. Herein, electronic device cleaning equipment according to Modified Example 1 includes the vapor supply nozzle 20 as the significant feature of the present embodiment, similarly to the electronic device cleaning equipment according to the present embodiment (see FIG. 5A and FIG. 5B), and further includes the vapor supply nozzle 19 as the significant feature of Embodiment 1.

In Evaluation Method 5, diselectrification was performed in the electronic device cleaning equipment according to Modified Example 1 for a predetermined diselectrification time period (30 seconds) in such a manner that water vapor was sprayed to the thermal oxide film (not show) formed on the wafer 1 and having a thickness of 300 nm by the vapor supply nozzle 19 arranged along the periphery of the cleaning stage 14 above the cleaning stage 14 while water vapor was sprayed to the chemical solution nozzle 11 by the vapor supply nozzle 20 arranged so as to surround the discharge port of the chemical solution nozzle 11. In this way, in Evaluation Method 5, diselectrification was performed not only on the chemical solution nozzle 11 but also on the obverse face of the wafer 1.

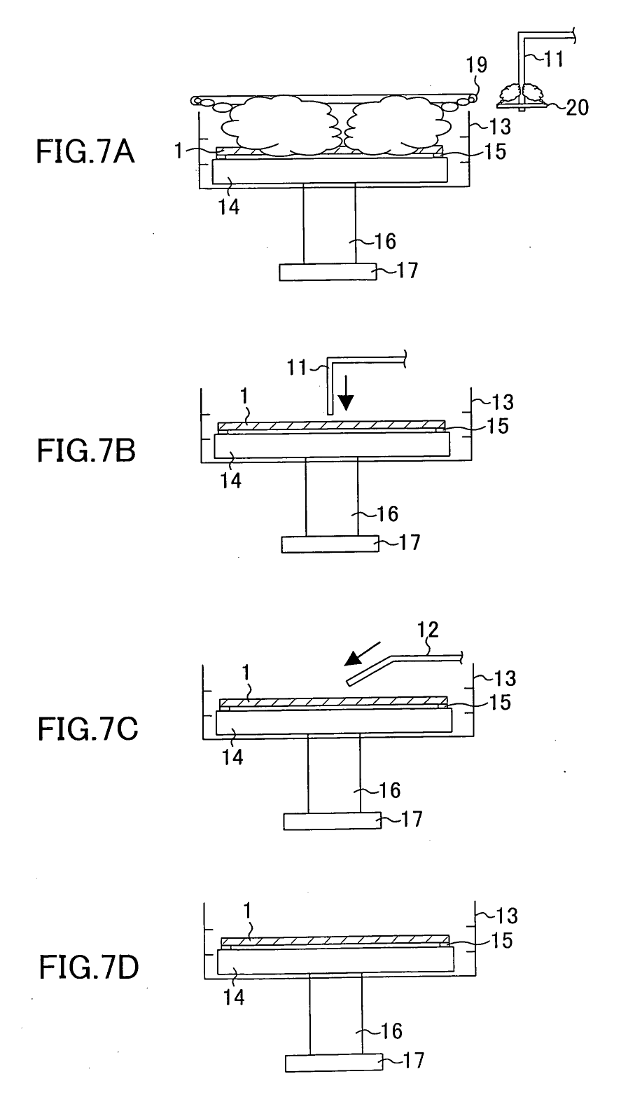

Subsequently, as shown in FIG. 7B, etching was performed on the thermal oxide film in such a manner that the DHF solution (Diluted Hydrofluoric acid, a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 7C and then was subjected to the drying process as shown in FIG. 7D.

Evaluation of defects was performed on the wafers subjected to the conventional electronic device cleaning method (Evaluation Method 3), the electronic device cleaning method according to the present embodiment (Evaluation Method 4), or the electronic device cleaning method according to Modified Example 1 (Evaluation Method 5) under the aforementioned cleaning conditions (etching conditions: 23° C., ten seconds, and HF:H₂O=1:10) by counting particles equal to or larger than 1.16 μm as defects by a particle counter. The defects generated at the respective wafers will be described below with reference to Table 2. Table 2 indicates the numbers and kinds of defects generated at the respective wafers.

TABLE 2

| | | | | Kinds of defects | |
|---|---|---|---|---|---|
| | Number of defects | | | Flaw | |
| | Before | After | Increased | by static | |
| | processing | processing | number | electricity | Particle |
| Conventional | 1 | 8 | 7 | 6 | 1 |
| Embodiment 2 | 5 | 5 | 0 | 0 | 0 |
| Modified | 4 | 4 | 0 | 0 | 0 |
| Example 1 | | | | | |

### Evaluation Result 3

As indicated in Table 2, Evaluation Result 3 in the present embodiment was the same as Evaluation Result 1 in Embodiment 1 (see above Evaluation Result 1), and it was confirmed that the number of defects after the processing increased when compared with that after the processing (specifically, seven defects increased). Further, a SEM defect inspection found that six defects out of the seven defects observed after the processing were hole-like flaws by static electricity (see D in FIG. 4A), and the other one defect was a particle.

### Evaluation Result 4

As indicated in Table 2, in the wafer subjected to the electronic device cleaning method according to the present embodiment, it was conformed that the numbers of defects before and after the processing were both five, which means no increase in the number of defects after the processing. Also, no defects (specifically, flaws by static electricity and particles) were observed at the obverse face of the wafer 1 after the processing.

### Evaluation Result 5

Table 2 further indicates that in the wafer subjected to the electronic device cleaning method according to Modified Example 1, the numbers of defects before and after the processing were both four, which means no increase in the number of defects after the processing when compared with that before the processing. Also, it was conformed that no defects (specifically, flaws by static electricity and particles) were observed at the obverse face of the wafer 1 after the processing.

As described above, the number of defects after the cleaning step increased in the wafer subjected to the conventional electronic device cleaning method while no increase was observed between the numbers of defects before and after the cleaning step in the wafer subjected to the electronic device cleaning method according to the present embodiment. Accordingly, it was found that spraying water vapor to the chemical solution nozzle 11 before the cleaning step diselectrifies static electricity present at the chemical solution nozzle 11, thereby reducing the potential difference between the chemical solution nozzle 11 and the obverse face of the wafer 1.

Similarly to the present embodiment, no increase was also observed between the numbers of defects before and after the cleaning step in the wafer subjected to the electronic device cleaning according to Modified Example 1, and accordingly, it was found that spraying water vapor to both the obverse face of the wafer 1 and the chemical solution nozzle 11 before the cleaning step reduces the potential difference between the chemical solution nozzle 11 and the obverse face of the wafer 1. Though it was confirmed only that the numbers of defects observed after the cleaning step did not increase in both Evaluation Results 4 and 5, further reduction in the potential difference between the chemical solution nozzle 11 and the obverse face of the wafer 1 can be inferred from the fact that diselectrification of not only the chemical solution nozzle 11 but also the obverse face of the wafer 1 as in Modified Example 1 reduced both the potential of the chemical solution nozzle 11 and the potential of the obverse face of the wafer 1.

As described above, in the electronic device cleaning method according to the present embodiment, water vapor is sprayed to the chemical solution nozzle 11 by the vapor supply nozzle 20 arranged so as to surround the discharge port of the chemical solution nozzle 11, as shown in FIG. 6A, before the cleaning step (see FIG. 6B to FIG. 6D).

Whereby, ionized water vapor neutralizes static electricity present at the chemical solution nozzle 11 (especially, the discharge port thereof) to lead to diselectrification of the static electricity present at the chemical solution nozzle 11, thereby lowering the potential of the discharge port of the chemical solution nozzle 11.

Specifically, the potential measured at the discharge port of the chemical solution nozzle 111 was −5 kV before the DHF solution was supplied onto the obverse face of the wafer 1 in the conventional electric device cleaning method. In contrast, in the electric device cleaning method according to the present embodiment, the potential measured at the discharge port of the chemical solution nozzle 11 was −1 kV before the DHF solution was supplied onto the obverse face of the wafer 1, namely, after the water vapor is supplied to the chemical solution nozzle 11. This means that supplying the water vapor to the chemical solution nozzle 11 lowers the potential of the discharge port of the chemical solution nozzle 11 (namely, a part of the chemical solution nozzle 11 which is to approach the obverse face of the wafer 1).

Accordingly, the potential difference between the obverse face of the wafer 1 and the chemical solution nozzle 11 can be reduced, preventing static electricity from being discharged in the space between the obverse face of the wafer 1 and the chemical solution nozzle 11 at chemical solution supply in the cleaning step (see FIG. 6B). This prevents formation of hole-lake flaws by static electricity at the obverse face of the wafer 1 and adhesion of particles thereto, which are caused by static electricity discharge.

Hence, in the electronic device cleaning method according to the present embodiment, the electronic device can be cleaned favorably with no defects (specifically, flaws by static electricity and particles) generated at the obverse face of the wafer 1, increasing the yield of the electronic device.

Further, in the electronic device cleaning method according to the present embodiment, water vapor supplied to the discharge port of the chemical solution nozzle 11 washes the discharge port of the chemical solution nozzle 11, which means that the chemical solution nozzle 11 is kept clean, attaining further favorable cleaning of the electronic device.

### Embodiment 3

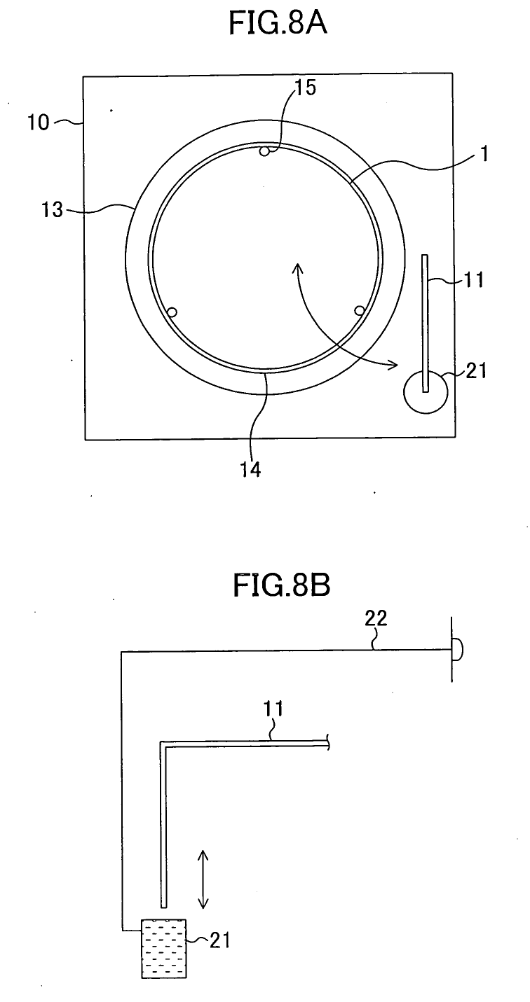

Electronic device cleaning equipment according to Embodiment 3 of the present invention will be described below with reference to FIG. 8A and FIG. 8B. FIG. 8A is a plan view showing a construction of the electronic device cleaning equipment according to Embodiment 3 of the present invention, namely, a plan view showing a cleaning chamber as viewed from above. FIG. 8B is an enlarged view of a characteristic part, namely, a diselectrification cup into which the chemical solution nozzle is to be dipped and, specifically, a plan view thereof as viewed from a side of the chemical solution nozzle. In FIG. 8A and FIG. 8B, the same reference numerals are assigned to the same constitutional elements as those in the electronic device cleaning equipment according to Embodiment 1 of the present invention, and the description of the same constitutional elements is omitted in the present embodiment.

The most significant feature of the present embodiment lies in that before the chemical solution is discharged onto the obverse face of the wafer 1 from the chemical solution nozzle 11, the discharge port of the chemical solution nozzle 11 is dipped into a solution (specifically, a chemical solution, soda water, water or the like) retained in a diselectrification cup 21 connected to the ground potential for diselectrifying static electricity present at the chemical solution nozzle 11

As shown in FIG. 8A, the electronic device cleaning equipment according to the present embodiment includes, similarly to that in Embodiment 1 (see FIG. 1): a cleaning chamber 10; a chemical solution nozzle 11; a water cleaning nozzle (not shown); a cleaning cup 13; a cleaning stage 14; a chuck pin 15; a rotary table (not shown); holding means (not shown); and a FFU (not shown). In addition, it includes, as the significant feature of the present embodiment, the diselectrification cup 21 into which the discharge port of the chemical solution nozzle 11 is to be dipped. The diselectrification cup 21 is made of a conductive material and is electrically connected to the ground potential via a ground lead 22 for the cup 21, as shown in FIG. 8B.

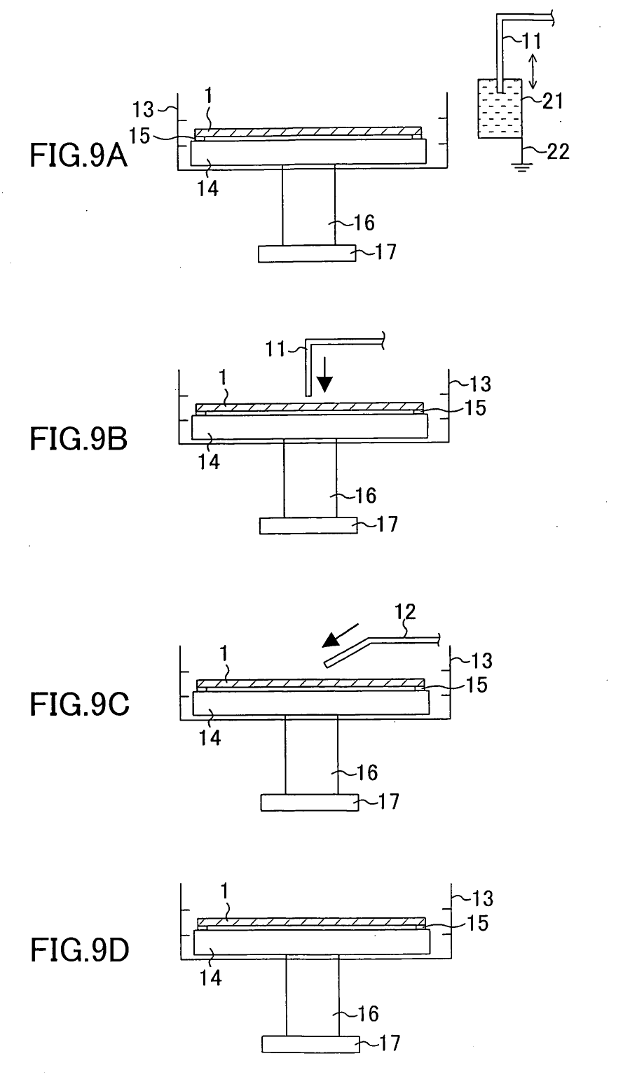

An electronic device cleaning method using the electronic device cleaning equipment according to Embodiment 3 of the present invention will be described with reference to FIG. 9A to FIG. 9D. FIG. 9A to FIG. 9D are sectional views showing main steps of the electronic device cleaning method according to Embodiment 3 of the present invention.

First, as shown in FIG. 9A, a wafer 1 having an obverse face at which an electronic device (not shown) is formed is placed on the processing face of the cleaning stage 14 with the chuck pin 15 interposed. Then, the chemical solution nozzle 11 is diselectrified for a predetermined diselectrification time period in such a manner that the discharge port of the chemical solution nozzle 11 is dipped into a solution (specifically, a chemical solution, soda water, water, or the like) retained in the diselectrification cup 21 electrically connected to the ground potential.

Subsequently, as shown in FIG. 9B, similarly to Embodiment 1, etching is performed on the obverse face of the wafer 1 for a predetermined etching time period in such a manner that a chemical solution is discharged onto the obverse face of the wafer 1 from the chemical solution nozzle 11 while the wafer 1 held on the cleaning stage 14 is rotated by the rotary table 16. Then, the obverse face of the wafer 1 is water cleaned as shown in FIG. 9C and then is subjected to the drying process as shown in FIG. 9D.

In order to prove effectiveness of the present embodiment, the following evaluation was performed on a wafer subjected to the conventional electronic device cleaning method, a wafer subjected to the electronic device cleaning method according to the present embodiment, and a wafer subjected to an electronic device cleaning method according to Modified Example 2.

### Evaluation Method 6

A wafer was cleaned by the conventional electronic device cleaning method. Evaluation Method 6 in the present embodiment is the same as Evaluation Method 1 in Embodiment 1 (see Evaluation Method 1), and therefore, the description of Evaluation Method 6 is omitted in the present embodiment. The potential measured at the discharge port of the chemical solution nozzle 111 was −5 kV before the DHF solution was supplied onto the obverse face of the wafer 1.

### Evaluation Method 7

A wafer was cleaned by the electronic device cleaning method according to the present embodiment under the following conditions.

Specifically, the chemical solution nozzle 11 was diselectrified for a predetermined diselectrification time period (30 seconds), as shown in FIG. 9A, in such a manner that the discharge port of the chemical solution nozzle 11 was dipped into the solution (specifically, a chemical solution, soda water, water or the like) electrically connected to the ground potential. The potential measured at the discharge port of the chemical solution nozzle 11 was −0.5 kV after the diselectrification of the chemical solution nozzle 11, namely, before the DHF solution was supplied onto the obverse face of the wafer 1.

Subsequently, as shown in FIG. 9B, etching was performed on the thermal oxide film (not shown) formed on the wafer 1 and having a thickness of 300 nm in such a manner that the DHF solution (Diluted Hydrofluoric acid, a mixed solution of which volume ratio HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 9C and then was subjected to the drying process as shown in FIG. 9D.

### Evaluation Method 8

A wafer was cleaned by the electronic device cleaning method according to Modified Example 2 under the following conditions. Herein, electronic device cleaning equipment according to the Modified Example 2 includes the diselectrification cup 21 as the significant feature of the present embodiment, similarly to the electronic device cleaning equipment according to the present embodiment (see FIG. 8A and FIG. 8B), and further includes the vapor supply nozzle 19 as the significant feature of Embodiment 1.

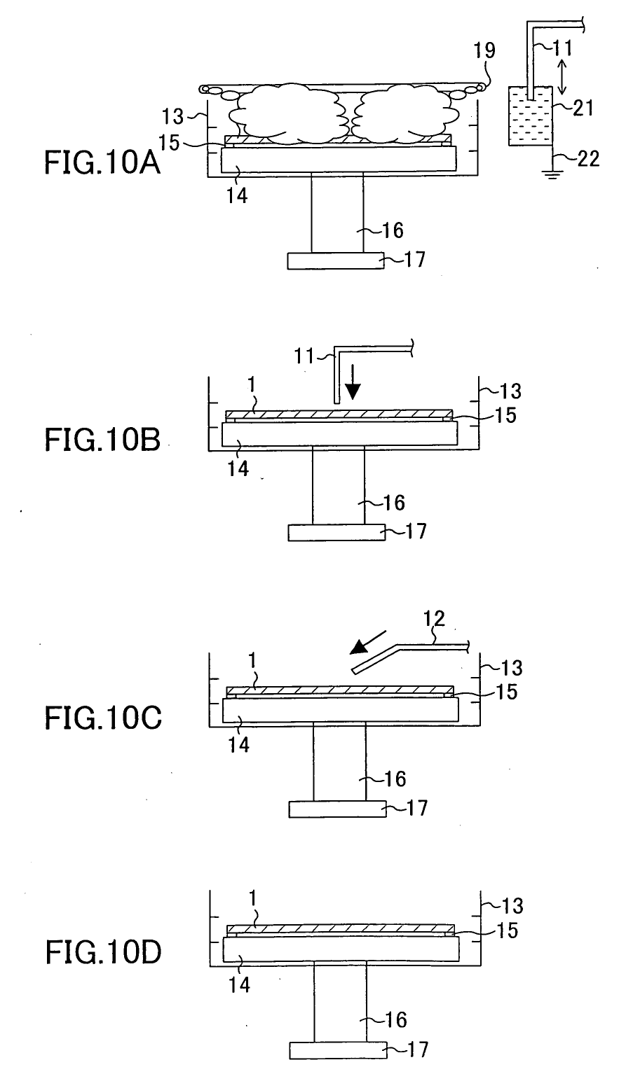

In Evaluation Method 8, diselectrification was performed in the electronic device cleaning equipment according to Modified Example 2 for a predetermined diselectrification time period (30 seconds), as shown in FIG. 10A, in such a manner that the discharge port of the chemical solution nozzle 11 was dipped into the solution (specifically, a chemical solution, soda water, water, or the like) electrically connected to the ground potential while the water vapor was sprayed to the thermal oxide film (not show) formed on the wafer 1 and having a thickness of 300 nm by the vapor supply nozzle 19 arranged along the periphery of the cleaning stage 14 above the cleaning stage 14. In this way, in Evaluation Method 8, diselectrification was performed not only on the chemical solution nozzle 11 but also on the obverse face of the wafer 1.

Subsequently, as shown in FIG. 10B, etching was performed on the thermal oxide film in such a manner that the DHF solution (a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 10C and then was subjected to the drying process as shown in FIG. 10D.

Evaluation of defects was performed on the wafers subjected to the conventional electronic device cleaning method (Evaluation Method 6), the electronic device cleaning method according to the present embodiment (Evaluation Method 7), or the electronic device cleaning method according to Modified Example 2 (Evaluation Method 8) under the aforementioned cleaning conditions (etching conditions: 23° C., ten seconds, and HF:H₂O=1:10) by counting particles equal to or larger than 0.16 μm as defects by a particle counter. The defects generated at the respective wafers will be described below with reference to Table 3. Table 3 indicates the numbers and kinds of defects generated at the respective wafers.

TABLE 3

| | | | | Kinds of defects | |
|---|---|---|---|---|---|
| | Number of defects | | | Flaw | |
| | Before | After | Increased | by static | |
| | processing | processing | number | electricity | Particle |
| Conventional | 1 | 8 | 7 | 6 | 1 |
| Embodiment 3 | 1 | 1 | 0 | 0 | 0 |
| Modified | 4 | 4 | 0 | 0 | 0 |
| Example 2 | | | | | |

### Evaluation Result 6

As indicated in Table 3, Evaluation Result 6 in the present embodiment was the same as Evaluation Result 1 in Embodiment 1 (see above Evaluation Result 1), and it was confirmed that the number of defects after the processing increased when compared with that before the processing (specifically, seven defects increased). Further, a SEM defect inspection found that six defects out of the seven defects observed after the processing were hole-like flaws by static electricity (see D in FIG. 4A), and the other one defect was a particle.

### Evaluation Result 7

As indicated in Table 3, in the wafer subjected to the electronic device cleaning method according to the present embodiment, the numbers of defects before and after the processing were both one, which means no increase in the number of defects after the processing. Also, it was conformed that no defects (specifically, flaws by static electricity and particles) were observed at the obverse face of the wafer 1 after the processing.

### Evaluation Result 8

Table 3 further indicates that in the wafer subjected to the electronic device cleaning method according to Modified Example 2, the numbers of defects before and after the processing were both four, which means no increase in the number of defects after the processing. Also, it was conformed that no defects (specifically, flaws by static electricity and particles) were observed at the obverse face of the wafer 1 after the processing.

As described above, the number of defects after the cleaning step increased in the wafer subjected to the conventional electronic device cleaning method while no increase was observed between the numbers of defects before and after the cleaning step in the wafer subjected to the electronic device cleaning method according to the present embodiment. Accordingly, it was found that dipping the discharge port of the chemical solution nozzle 11 into the solution (specifically, a chemical solution, soda water, water, or the like) electrically connected to the ground potential before the cleaning step diselectrifies static electricity present at the chemical solution nozzle 11 (especially, the discharge port thereof), thereby reducing the potential difference between the chemical solution nozzle 11 and the obverse face of the wafer 1.

Referring to the wafer subjected to the electronic device cleaning method according to Modified Example 2, no increase was observed between the numbers of defects before and after the cleaning step, and accordingly, it was also found that spraying water vapor to the obverse face of the wafer 1 and dipping the discharge port of the chemical solution nozzle 11 into the solution (specifically, a chemical solution, soda water, water, or the like) electrically connected to the ground potential before the cleaning step reduces the potential difference between the chemical solution nozzle 11 and the obverse face of the wafer 1. Though it was confirmed only that the numbers of defects observed after the cleaning step did not increase in both Evaluation Results 7 and 8, further reduction in the potential difference between the chemical solution nozzle 11 and the obverse face of the wafer 1 can be inferred from the fact that diselectrification of not only the chemical solution nozzle 11 but also the wafer 1 as in Modified Example 2 reduced both the potential of the chemical solution nozzle 11 and the potential of the obverse face of the wafer 1.

As described above, in the electronic device cleaning method according to the present embodiment, the discharge port of the chemical solution nozzle 11 is dipped into the solution (specifically, a chemical solution, soda water, water, or the like) electrically connected to the ground potential, as shown in FIG. 9A, before the cleaning step (see FIG. 9B to FIG. 9D).

Whereby, static electricity present at the chemical solution nozzle 11 (especially, the discharge port thereof) is neutralized to lead to diselectrification of the static electricity present at the chemical solution nozzle 11, thereby lowering the potential of the discharge port of the chemical solution nozzle 11.

Specifically, the potential measure at the discharge port of the chemical solution nozzle 111 was −5 kV before the DHF solution was supplied onto the obverse face of the wafer 1 in the conventional electric device cleaning method. In contrast, the potential measured at the discharge port of the chemical solution nozzle 11 was −0.5 kV before the DHF solution was supplied onto the obverse face of the wafer 1, namely, after the discharge port of the chemical solution nozzle 11 was dipped into the solution electrically connected to the ground potential in the electric device cleaning method according to the present embodiment. This means that dipping the discharge port of the chemical solution nozzle 11 into the solution (specifically, a chemical solution, soda water, water, or the like) electrically connected to the ground potential lowers the potential of the discharge port of the chemical solution nozzle 11 (namely, a part of the chemical solution nozzle 11 which is to approach the obverse face of the wafer 1).

Accordingly, the potential difference between the obverse face of the wafer 1 and the chemical solution nozzle 11 can be reduced, preventing static electricity from being discharged in the space between the obverse face of the wafer 1 and the chemical solution nozzle 11 at chemical solution supply in the cleaning step (see FIG. 9B). This prevents formation of hole-lake flaws by static electricity at the obverse face of the wafer 1 and adhesion of particles thereto, which are caused by static electricity discharge.

Hence, in the electronic device cleaning method according to the present embodiment, the electronic device can be cleaned favorably with no defects (specifically, flaws by static electricity and particles) generated at the obverse face of the wafer 1, increasing the yield of the electronic device.

Further, in the electronic device cleaning method according to the present embodiment, when the discharge port of the chemical solution nozzle 11 is dipped into the solution electrically connected to the ground potential, crystals as a precipitate of the chemical solution (for example, the DHF solution) which adhere to the discharge port of the chemical solution nozzle 11 are dissolved and removed surely in the solution. Particles are generated in such a way that such crystals fall on and adhere to the obverse face of the wafer. However, no crystals adhere to the discharge port of the chemical solution nozzle 11 and fall on the obverse face of the wafer 1 in the present embodiment. As a result, particles are prevented from being generated at the obverse face of the wafer 1, attaining further favorable cleaning of the electronic device.

### Embodiment 4

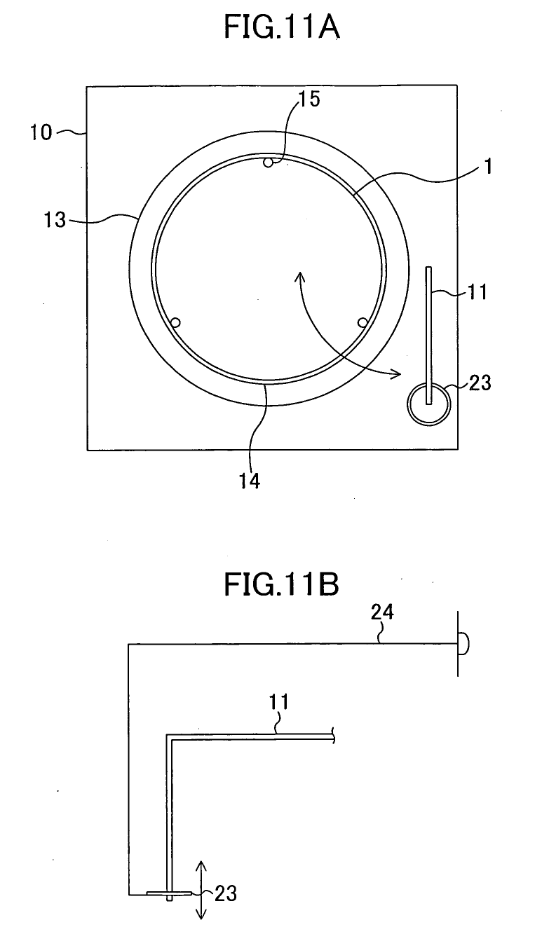

Electronic device cleaning equipment according to Embodiment 4 of the present invention will be described below with reference to FIG. 11A and FIG. 11B. FIG. 11A is a plan view showing a construction of the electronic device cleaning equipment according to Embodiment 4 of the present invention, specifically, a plan view showing a cleaning chamber as viewed from above. FIG. 11B is an enlarged view of a characteristic part, namely, a conductive ring for allowing the chemical solution nozzle to be in contact with or approach it, and, specifically, a plan view thereof as viewed from a side of the chemical solution nozzle. In FIG. 11A and FIG. 11B, the same reference numerals are assigned to the same constitutional elements as those in the electronic device cleaning equipment according to Embodiment 1 of the present invention, and the description of the same constitutional elements is omitted in the present embodiment.

The most significant feature of the present embodiment lies in that before the chemical solution is discharged onto the obverse face of the wafer 1 from the chemical solution nozzle 11, the chemical solution nozzle 11 is allowed to be in contact with or approach a conductive ring 23 electrically connected to the ground potential for diselectrifying static electricity present at the chemical solution nozzle 11.

As shown in FIG. 11A, the electronic device cleaning equipment according to the present embodiment includes, similarly to that in Embodiment 1 (see FIG. 1): a cleaning chamber 10; a chemical solution nozzle 11; a water cleaning nozzle (not shown); a cleaning cup 13; a cleaning stage 14; a chuck pin 15; a rotary table (not shown); holding means (not shown); and a FFU (not shown). It further includes the conductive ring 23 for allowing the chemical solution nozzle 11 to be in contact with or approach it, which is the most significant feature of the present embodiment. The conductive ring 23 is arranged so as to surround the discharge port of the chemical solution nozzle 11 in a perpendicular direction relative to the chemical solution nozzle 11 as viewed from a side of the chemical solution nozzle 11, as shown in FIG. 11B. Further, the conductive ring 23 is made of a conductive material and is electrically connected to the ground potential via a ground lead 24 for the ring 23.

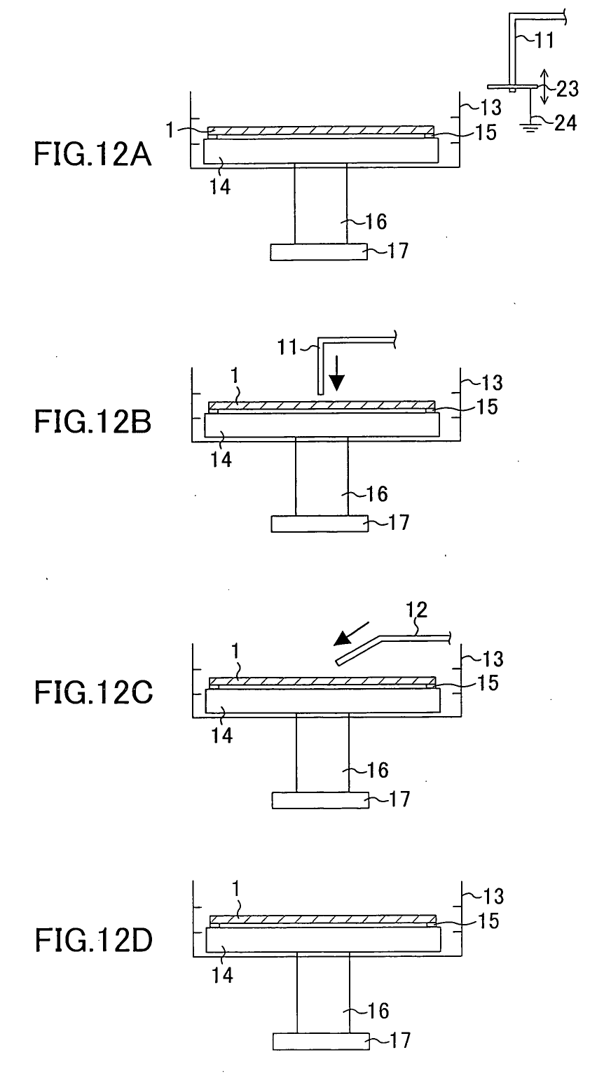

An electronic device cleaning method using the electronic device cleaning equipment according to Embodiment 4 of the present invention will be described with reference to FIG. 12A to FIG. 12D. FIG. 12A to FIG. 12D are sectional views showing main steps of the electronic device cleaning method according to Embodiment 4 of the present invention.

First, as shown in FIG. 12A, a wafer 1 having an obverse face at which an electronic device (not shown) is formed is placed on the processing face of the cleaning stage 14 with the chuck pin 15 interposed. Then, the chemical solution nozzle 11 is diselectrified for a predetermined diselectrification time period in such a manner that the discharge port of the chemical solution nozzle 11 is inserted within and in contact with or approach the conductive ring 23 electrically connected to the ground potential.

Subsequently, as shown in FIG. 12B, similarly to Embodiment 1, etching is performed on the obverse face of the wafer 1 for a predetermined etching time period in such a manner that a chemical solution is discharged onto the obverse face of the wafer 1 from the chemical solution nozzle 11 while the wafer 1 held on the cleaning stage 14 is rotated by the rotary table 16. Then, the obverse face of the wafer 1 is water cleaned as shown in FIG. 12C and then is subjected to the drying process as shown in FIG. 12D.

In order to prove effectiveness of the present embodiment, the following evaluation was performed on a wafer subjected to the conventional electronic device cleaning method, a wafer subjected to the electronic device cleaning method according to the present embodiment, and a wafer subjected to an electronic device cleaning method according to Modified Example 3.

### Evaluation Method 9

A wafer was cleaned by the conventional electronic device cleaning method. Evaluation Method 9 of the present embodiment is the same as Evaluation Method 1 in Embodiment 1 (see Evaluation Method 1), and therefore, the description of Evaluation Method 9 is omitted in the present embodiment. The potential measured at the discharge port of the chemical solution nozzle 111 was −5 kV before the DHF solution was supplied onto the obverse face of the wafer 1.

### Evaluation Method 10

A wafer was cleaned by the electronic device cleaning method according to the present embodiment under the following conditions.

Specifically, the chemical solution nozzle 11 was diselectrified for a predetermined diselectrification time period (30 seconds), as shown in FIG. 12A, in such a manner that the discharge port of the chemical solution nozzle 11 was inserted within and was in contact with or approached the conductive ring 23 electrically connected to the ground potential. The potential measured at the discharge port of the chemical solution nozzle 11 was −1 kV after the diselectrification of the chemical solution nozzle 11, namely, before the DHF solution was supplied onto the obverse face of the wafer 1.

Subsequently, as shown in FIG. 12B, etching was performed on the thermal oxide film (not shown) formed on the wafer 1 and having a thickness of 300 nm in such a manner that the DHF solution (Diluted Hydrofluoric acid, a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 12C and then was subjected to the drying process as described above as shown in FIG. 12D.

### Evaluation Method 11

A wafer was cleaned by the electronic device cleaning method according to Modified Example 3 under the following conditions. Herein, electronic device cleaning equipment according to Modified Example 3 includes the conductive ring 23 as the significant feature of the present embodiment, similarly to in the electronic device cleaning equipment according to the present embodiment (see FIG. 11A and FIG. 11B), and further includes the vapor supply nozzle 19 as the significant feature of Embodiment 1.

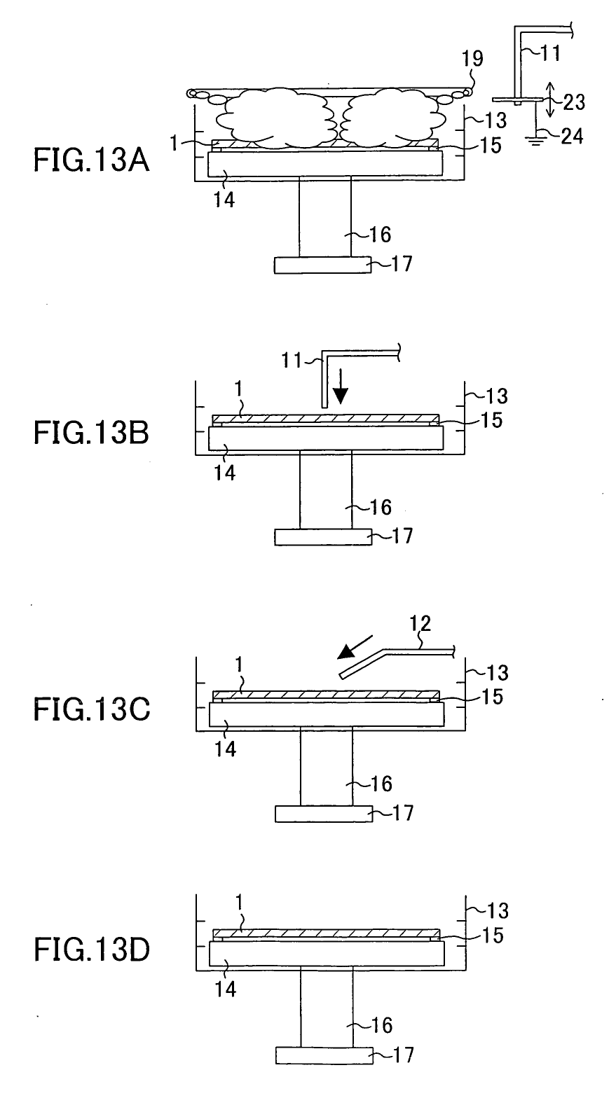

In Evaluation Method 11, diselectrification was performed in the electronic device cleaning equipment according to Modified Example 3 for a predetermined diselectrification time period (30 seconds), as shown in FIG. 13A, in such a manner that water vapor was sprayed to the obverse face of the thermal oxide film (not show) formed on the wafer 1 and having a thickness of 300 nm by the vapor supply nozzle 19 arranged along the periphery of the cleaning stage 14 above the cleaning stage 14 while the discharge port of the chemical solution nozzle 21 was inserted within and was in contact with or approached the conductive ring 23 electrically connected to the ground potential. In this way, in Evaluation Method 11, diselectrification was performed not only on the chemical solution nozzle 11 but also on the obverse face of the wafer 1.

Subsequently, as shown in FIG. 13B, etching was performed on the thermal oxide film in such a manner that the DHF solution (a mixed solution of which volume ratio of HF:H₂O is 1:10) was discharged onto the thermal oxide film from the chemical solution nozzle 11 for ten seconds at room temperature (23° C.) by the wafer center discharge method while the wafer 1 held on the cleaning stage 14 was rotated by the rotary table 16. Then, the obverse face of the wafer 1 was water cleaned as shown in FIG. 13C and then was subjected to the drying process as shown in FIG. 13D.

Evaluation of defects was performed on the wafers subjected to the conventional electronic device cleaning method (Evaluation Method 9), the electronic device cleaning method according to the present embodiment (Evaluation Method 10), or the electronic device cleaning method according to Modified Example 3 (Evaluation Method 11) under the aforementioned cleaning conditions (etching conditions: 23° C., ten seconds, and HF:H₂O=1:10) by counting particles equal to or larger than 0.16 μm by a particle counter. The defects generated at the respective wafers will be described below with reference to Table 4. Table 4 indicates the numbers and kinds of defects generated at the respective wafers.

TABLE 4

| | | | | Kinds of defects | |
|---|---|---|---|---|---|
| | Number of defects | | | Flaw | |
| | Before | After | Increased | by static | |
| | processing | processing | number | electricity | Particle |
| Conventional | 1 | 8 | 7 | 6 | 1 |
| Embodiment 4 | 3 | 3 | 0 | 0 | 0 |
| Modified | 2 | 2 | 0 | 0 | 0 |
| Example 3 | | | | | |

### Evaluation Result 9

As indicated in Table 4, Evaluation Result 9 in the present embodiment was the same as Evaluation Result 1 in Embodiment 1 (see Evaluation Result 1), and it was confirmed that the number of defects after the processing increased when compared with that before the processing (specifically, seven defects increased). Further, a SEM defect inspection found that six defects out of the seven defects observed after the processing were hole-like flaws by static electricity (see D in FIG. 4A), and the other one defect was a particle.

### Evaluation Result 10

As indicated in Table 4, in the wafer subjected to the electronic device cleaning method according to the present embodiment, the numbers of defects before and after the processing were both three, which means no increase in the number of defects after the processing. Also, it was conformed that no defects (specifically, flaws by static electricity and particles) were observed at the obverse face of the wafer 1 after the processing.

### Evaluation Result 11

Table 4 further indicates that in the wafer subjected to the electronic device cleaning method according to Modified Example 3, the numbers of defects before and after the processing were both two, which means no increase in the number of defects after the processing. Also, it was conformed that no defects (specifically, flaws by static electricity and particles) were observed at the obverse face of the wafer 1 after the processing.

As described above, the number of defects after the cleaning step increased in the wafer subjected to the conventional electronic device cleaning method while no increase was observed between the numbers of defects before and after the cleaning step in the wafer subjected to the electronic device cleaning method according to the present embodiment. Accordingly, it was found that when the chemical solution nozzle 11 is arrowed to be in contact with or approach the conductive ring 23 electrically connected to the ground potential before the cleaning step, static electricity present at the chemical solution nozzle 11 is diselectrified, thereby reducing the potential difference between the chemical solution nozzle 11 and the obverse face of the wafer 1.

Further, in the wafer subjected to the electronic device cleaning method according to Modified Example 3, no increase in the number of defects after the cleaning step was observed, similarly to the present embodiment. Accordingly, this proves that when water vapor is sprayed to the obverse face of the wafer 1 and the chemical solution nozzle 11 is allowed to be in contact with or approach the conductive ring 23 electrically connected to the ground potential before the cleaning step, the potential difference between the chemical solution nozzle 11 and the obverse face of the wafer 1 is reduced. Though it was confirmed only that the numbers of defects observed after the cleaning step did not increase in both Evaluation Results 10 and 11, further reduction in the potential difference between the chemical solution nozzle 11 and the obverse face of the wafer 1 can be inferred from the fact that diselectrification of not only the chemical solution nozzle 11 but also the wafer 1 as in Modified Example 3 reduced both the potential of the chemical solution nozzle 11 and the potential of the obverse face of the wafer 1.

As described above, in the electronic device cleaning method according to the present embodiment, the discharge port of the chemical solution nozzle 11 is inserted within and is in contact with or approaches the conductive ring 23 electrically connected to the ground potential, as shown in FIG. 12A, before the cleaning step (see FIG. 12B to FIG. 12D).

Whereby, static electricity present at the chemical solution nozzle 11 (especially, the discharge port thereof) is neutralized to lead to diselectrification of the static electricity present at the chemical solution nozzle 11, thereby lowering the potential of the discharge port of the chemical solution nozzle 11.

Specifically, the potential measured at the discharge port of the chemical solution nozzle 111 was −5 kV before the DHF solution was supplied onto the obverse face of the wafer 1 in the conventional electric device cleaning method. In contrast, in the electric device cleaning method according to the present embodiment, the potential measured at the discharge port of the chemical solution nozzle 11 was −1 kV before the DHF solution was supplied onto the obverse face of the wafer 1, namely, after the chemical solution nozzle 11 was in contact with or approached the conductive ring 23 electrically connected to the ground potential. This means that when the chemical solution nozzle 11 is in contact with or approaches the conductive ring 3 electrically connected to the ground potential, the potential of the discharge port of the chemical solution nozzle 11 (namely, a part of the chemical solution nozzle 11 which is to approach the obverse face of the wafer 1) can be lowered.

Accordingly, the potential difference between the obverse face of the wafer 1 and the chemical solution nozzle 11 can be reduced, preventing static electricity from being discharged in the space between the obverse face of the wafer 1 and the chemical solution nozzle 11 at chemical solution supply in the cleaning step (see FIG. 12B). This prevents formation of hole-lake flaws by static electricity at the obverse face of the wafer 1 and adhesion of particles thereto, which are caused by static electricity discharge.

Hence, in the electronic device cleaning method according to the present embodiment, the electronic device can be cleaned favorably with no defects (specifically, flaws by static electricity and particles) generated at the obverse face of the wafer 1, increasing the yield of the electronic device.

Further, in the electronic device cleaning method according to the present embodiment, the chemical solution nozzle 11 is allowed to be in contact with or approach the conductive ring 23 electrically connected to the ground potential for diselectrifying static electricity present at the chemical solution nozzle 11, which means that the chemical solution nozzle 11 does not get wet in the diselectrifying step.

In Embodiment 2 (diselectrification by spraying water vapor to the chemical solution nozzle 11) and Embodiment 3 (diselectrification by dipping the chemical solution nozzle 11 into the electrically grounded solution), the chemical solution nozzle 11 gets wet in the diselectrifying step by the water vapor supplied to the chemical solution nozzle 11 or the solution (specifically, a chemical solution, soda water, water, or the like). This may leads to mixture of a component of the water vapor or the solution other than the chemical solution discharged to the obverse face of the wafer 1 from the chemical solution nozzle 11 with the chemical solution to cause change in composition of the chemical solution, thereby varying the cleaning ability for the electronic device.

Particularly, in the case where an organic solution to be recycled is employed as the chemical solution introduced to the chemical solution nozzle 11, in Embodiments 2 and 3, recycle of the chemical solution introduced in the chemical solution nozzle 11 may lead to re-mixture of a component of the water vapor or the solution other than the chemical solution with the chemical solution, causing chronological change in composition of the chemical solution, rather than isolated change in composition thereof caused due to one-time mixture of a component of the water vapor or the solution other than the chemical solution with the chemical solution. Accordingly, the cleaning ability for the electronic device may vary considerably.

In contrast, in the present embodiment (diselectrification by allowing the chemical solution nozzle 1 to be in contact with or approach the electrically grounded conductive ring 23), static electricity present at the chemical solution nozzle 11 can be diselectrified without wetting the chemical solution nozzle 11 in the diselectrifying step. Accordingly, no change in composition is caused with no component other than the chemical solution mixed with the chemical solution introduced in the chemical solution nozzle 11, preventing the cleaning ability for the electronic device from varying. Hence, the electronic device can be cleaned further favorably.

Further, in the electronic device cleaning method according to the present embodiment, the conductive ring 23 is arranged so as to surround the side face of the chemical solution nozzle 11 for allowing every part of the side face of the chemical solution nozzle 11 to approach the conductive ring 23, thereby effectively diselectrifying static electricity present at the chemical solution nozzle 11. Particularly, in a case with considerable amount of charges at the chemical solution nozzle 11, the static electricity present at the chemical solution nozzle 11 can be diselectrified surely only by allowing the chemical solution nozzle 11 to approach the conductive ring 23. The chemical solution nozzle 11 needs not be surely in contact with the conductive ring 23.

Embodiment 1 describes the case where the chemical solution nozzle 11 is employed as a chemical solution supplying apparatus. It is noted, however, that the present invention is not limited thereto and that any apparatus is applicable only if it has a function of supplying a chemical solution to the obverse face of the wafer 1.

In Embodiments 1 and 2, water vapor is sprayed to the wafer 1 (Embodiment 1) or the chemical solution nozzle 11 (Embodiment 2). The present invention is not limited thereto, and the same effects as in the present invention can be obtained when employing any vapor of soda water, alcohol or the like or any vapor of a mixture of water, soda water, alcohol, and the like.

As described above, the present invention is useful for electronic device cleaning equipment and electronic device cleaning methods and, particularly, useful for single-wafer electronic device cleaning equipment and single-wafer electronic device cleaning methods

What is claimed is:

1. Electronic device cleaning equipment, comprising:
a cleaning stage having a processing face on which a substrate having an obverse face at which an electronic device is formed is to be placed;
a vapor supply nozzle for supplying vapor to the obverse face of the substrate; and
chemical solution supply means for supplying a chemical solution to the obverse face of the substrate.

2. The electronic device cleaning equipment of claim 1,
wherein the chemical solution supply means is a chemical solution nozzle for discharging the chemical solution to the obverse face of the substrate.

3. The electronic device cleaning equipment of claim 1,
wherein the vapor supply nozzle is in the form capable of being arranged along the periphery of the cleaning stage above the cleaning stage.

4. The electronic device cleaning equipment of claim 1,
wherein the vapor includes at least one of water, soda water, and alcohol.

5. Electronic device cleaning equipment, comprising:
a cleaning stage having a processing face on which a substrate having an obverse face at which an electronic device is formed is to be placed;
a chemical solution nozzle for supplying a chemical solution to the obverse face of the substrate; and
a vapor supply nozzle for supplying vapor to the chemical solution nozzle.

6. The electronic device cleaning equipment of claim 5,
wherein the vapor supply nozzle is in the form capable of surrounding a discharge port of the chemical solution nozzle.

7. The electronic device cleaning equipment of claim 5,
wherein the vapor includes at least one of water, soda water, and alcohol.

8. Electronic device cleaning equipment, comprising:
a cleaning stage having a processing face on which a substrate having an obverse face at which an electronic device is formed is to be placed;
a chemical solution nozzle for supplying a chemical solution to the obverse face of the substrate; and
a conductive cup which retains a solution and is electrically grounded, a discharge port of the chemical solution nozzle being to be dipped into the solution.

9. The electronic device cleaning equipment of claim 8,
wherein the solution includes at least one of a chemical solution, soda water, and water.

10. Electronic device cleaning equipment, comprising:
a cleaning stage having a processing face on which a substrate having an obverse face at which an electronic device is formed is to be placed;
a chemical solution nozzle for supplying a chemical solution to the obverse face of the substrate; and
a conductive member for diselectrifying static electricity present at the chemical solution nozzle, the conductive member being grounded electrically.

11. The electronic device cleaning equipment of claim 10,
wherein the conductive member is in the form capable of surrounding a discharge port of the chemical solution nozzle.

12. An electronic device cleaning method, comprising the steps of:
(a) placing, on a processing face of a cleaning stage, a substrate having an obverse face at which an electronic device is formed;
(b) supplying vapor to the obverse face of the substrate; and
(c) supplying a chemical solution to the obverse face of the substrate after the step (b).

13. The electronic device cleaning method of claim 12,
wherein in the step (c), the chemical solution is discharged to the obverse face of substrate from a chemical solution nozzle.

14. The electronic device cleaning method of claim 12,
wherein in the step (b), the vapor is sprayed to the obverse face of the substrate by a vapor supply nozzle arranged along the periphery of the cleaning stage above the cleaning stage.

15. The electronic device cleaning method of claim 12,
wherein the vapor includes at least one of water, soda water, and alcohol.

16. An electronic device cleaning method, comprising the steps of:
(a) placing, on a processing face of a cleaning stage, a substrate having an obverse face at which an electronic device is formed;
(b) supplying vapor to a chemical solution nozzle; and
(c) supplying a chemical solution to the obverse face of the substrate from the chemical solution nozzle after the step (b).

17. The electronic device cleaning method of claim 16,
wherein in the step (b), the vapor is sprayed to the chemical solution nozzle by a vapor supply nozzle arranged so as to surround a discharge port of the chemical solution nozzle.

18. The electronic device cleaning method of claim 16,
wherein the vapor includes at least one of water, soda water, and alcohol.

19. An electronic device cleaning method, comprising the steps of:
(a) placing, on a processing face of a cleaning stage, a substrate having an obverse face at which an electronic device is formed;
(b) dipping a discharge port of a chemical solution nozzle into an electrically grounded solution; and
(c) supplying a chemical solution to the obverse face of the substrate from the chemical solution nozzle after the step (b).

20. The electronic device cleaning method of claim 19,
wherein the solution includes at least one of a chemical solution, soda water, and water.

21. An electronic device cleaning method, comprising the steps of:
(a) placing, on a processing face of a cleaning stage, a substrate having an obverse face at which an electronic device is formed;
(b) diselectrifying static electricity present at a chemical solution nozzle with the use of an electrically grounded conductive member; and
(c) supplying a chemical solution to the obverse face of the substrate from the chemical solution nozzle after the step (b).

22. The electronic device cleaning method of claim 21,
wherein in the step (b), the static electricity present at the chemical solution nozzle is diselectrified with the use of the conductive member arranged so as to surround a discharge port of the chemical solution nozzle.
